(19) United States
(12) Patent Application Publication
(10) Pub. No.: US 2007/0123411 A1
(43) Pub. Date: May 31, 2007

(54) Optical glass and optical element

(75) Inventor: Toshiharu Mori, Settsu-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/592,641

(22) Filed: Nov. 3, 2006

(30) Foreign Application Priority Data
Nov. 25, 2005 (JP) 2005-339555

(51) Int. Cl. C03C 3/062

(52) U.S. Cl. 501/73

(57) ABSTRACT

Optical glass for press-molding of the present invention includes the following glass components in % by weight: 10 to 38% of SiO₂, 15 to 40% of B₂O₃, 4 to 14% of Li₂O, 0 to 5% (zero inclusive) of Na₂O, 0 to 5% (zero inclusive) of K₂O, where a total content of Li₂O+Na₂O+K₂O is equal to 4 to 20%, and 0 to 10% (zero inclusive) of MgO, 0 to 10% (zero inclusive) of CaO, 0 to 10% (zero inclusive) of BaO, 0 to 10% (zero inclusive) of SrO, and 15 to 39% of ZnO, where a total content of MgO+CaO+BaO+SrO+ZnO is equal to 15 to 39%. Here, in view of improvement in glass stability and adjustment of optical constants, one or two or more kinds of the following glass components may be further contained in % by weight, 0 to 20% of Al₂O₃, 0 to 5% of Y₂O₃, 0 to 5% of La₂O₃, 0 to 5% of Gd₂O₃, 0 to 5% TiO₂, 0 to 5% of ZrO₂, 0 to 5% of Nb₂O₅, 0 to 5% of Ta₂O₅, 0 to 10% of WO₃, 0 to 2% of Sb₂O₃, and 0 to 5% of Bi₂O₃.

### BACKGROUND OF THE INVENTION

This application is based on Japanese Patent Application No. 2005-339555 filed on Nov. 25, 2005, the contents of which are hereby incorporated by reference.

1. Field of the Invention

The present invention relates to an optical glass and an optical element formed of this optical glass, and more specifically to an optical glass suitable for press-molding and an optical element formed of this optical glass.

2. Description of Related Arts

As a method of manufacturing glass optical elements, such as glass lenses and the like, a so-called press-molding method of molding a glass heated to the yield temperature (At) or higher by pressing it with a heated mold composed of a pair of upper and lower molds has been widely used in recent years, because this method requires less manufacturing processes than a conventional molding method of polishing glass, thus achieving manufacturing in short time and also at a low price.

This press-molding method can be roughly classified into a reheating method and a direct press method. In the reheating method, a Gob preform or a ground preform in the form of a substantially final product is first prepared, then either of these preforms is reheated to the softening point or higher, and then press-molded into a final product form by use of the heated pair of upper and lower molds. On the other hand, in the direct press method, molten glass is directly fed on a heated mold from a glass fusion furnace, and then is press-molded into a final product form. In either of these press-molding methods, to form the glass, it is required to heat the press mold to nearly the glass transition temperature (hereinafter may be indicated as “Tg”) or higher. Thus, with a higher glass Tg, surface oxidation of the press mold and metal composition change thereof are more likely to occur, resulting in shorter mold life, which in turn leads to an increase in the manufacturing costs. Although molding under the atmosphere of inactive gas, such as nitrogen or the like, permits suppressing mold deterioration, this results in a complicated molding device for atmosphere control and also requires the running cost for the inactive gas, thus leading to an increase in the manufacturing costs. Therefore, glass having as low Tg as possible is preferable for use in the press-molding method. Moreover, in view of improving the devitrification resistance, as with Tg, lower liquid phase temperature (hereinafter may be indicated as “T_{L}”) is preferable.

However, there has arisen in recent years concern about adverse effect on the human body exerted by a lead compound which has been conventionally used to lower the Tg. Thus, there has been increasingly strong market demand for not using the lead compound. Thus, various studies and suggestions (for example, those disclosed in patent documents 1 to 3) have been made on a technology of lowering the Tg and the T_{L} without using the lead compound.

However, optical glass disclosed in patent documents 1 to 3 do not have satisfactorily low Tg, thus suffering from a problem of short mold life and also a problem with the devitrification resistance due to the TL which still remains high.

[Patent Document 1] JP-A-H03-5341

[Patent Document 2] JP-A-H06-107425

[Patent Document 3] JP-A-2003-176151

### SUMMARY OF THE INVENTION

In view of such conventional problems, the present invention has been made, and it is an object of the invention to provide an optical glass which contains substantially no compounds such as lead, arsenic, and the like, which has low Tg and T_{L} and excellent devitrification resistance, and which is suitable for press-molding.

It is another object of the invention to provide an optical element of high productivity which has a predetermined optical constant and which contains substantially no compounds such as lead, arsenic, and the like.

The inventor, through repeated keen studies in order to achieve the object described above, has achieved the invention as a result of finding out that in composition of SiO₂—B₂O₃ glass, a predetermined content of alkaline component, such as Li₂O or the like permits a decrease in the Tg and a relatively large ZnO content provides viscosity suitable for press-molding while maintaining a predetermined optical constant.

Specifically, optical glass for press-molding according to one aspect of the invention includes the following glass components in % by weight: 10 to 38% of SiO₂, 15 to 40% of B₂O₃, 4 to 14% of Li₂O, 0 to 5% (zero inclusive) of Na₂O, 0 to 5% (zero inclusive) of K₂O, where a total content of Li₂O+Na₂O+K₂O is equal to 4 to 20%, 0 to 10% (zero inclusive) of MgO, 0 to 10% (zero inclusive) of CaO, 0 to 10% (zero inclusive) of BaO, 0 to 10% (zero inclusive) of SrO, and 15 to 39% of ZnO, where a total content of MgO+CaO+BaO+SrO+ZnO is equal to 15 to 39%. Hereinafter, symbol “%” denotes weight % unless otherwise specified. With such configuration, the optical glass for press-molding according to one aspect of the invention provides optical constants of an intermediate refractive index and low dispersion without using a compound such as lead or arsenic which is a concern that may adversely affect the human body. Moreover, the optical glass also is low in Tg and is excellent in press moldability, and further is low in TL and excellent in devitrification resistance.

Now, in view of improvement in the glass stability and adjustment of an optical constant, the optical glass may further contain one or two or more kinds of the following glass components in % by weight: 0 to 20% of Al₂O₃, 0 to 5% of Y₂O₃, 0 to 5% of La₂O₃, 0 to 5% of Gd₂O₃, 0 to 5% of TiO₂, 0 to 5% of ZrO₂, 0 to 5% of Nb₂O₅, 0 to 5% of Ta₂O₅, 0 to 10% of WO₃, 0 to 2% of Sb₂O₃, and 0 to 5% of Bi₂O₃.

According to another aspect of the invention, an optical element formed of the optical glass is provided. According an optical element with to such configuration, properties of the optical glass can be provided and higher manufacturing efficiency and cost reduction can be achieved. As such an optical element, a lens, a prism, a mirror, and the like are preferable.

An optical glass according to still another aspect of the invention includes the following glass components in % by weight: 10 to 38% of SiO₂, 0 to 20% (zero inclusive) of Al₂O₃, 15 to 40% of B₂O₃, 4 to 14% of Li₂O, 0 to 5% (zero inclusive) of Na₂O, 0 to 5% (zero inclusive) of K₂O, where a total content of Li₂O+Na₂O+K₂O is equal to 4 to 20%, 0 to 10% (zero inclusive) of MgO, 0 to 10% (zero inclusive) of CaO, 0 to 10% (zero inclusive) of BaO, 0 to 10% (zero inclusive) of SrO, and 15 to 39% of ZnO, where a total content of MgO+CaO+BaO+SrO+ZnO is equal to 15 to 39%. With such configuration, the optical glass of the invention provides optical constants of intermediate refractive index and low dispersion without using a compound such as lead, arsenic, or the like, which is a concern that may adversely affect the human body. Moreover, the optical glass is low in Tg and excellent in press moldability, and further low in T_{L} and excellent in devitrification resistance.

### DETAILED DESCRIPTION OF THE PREFERRED EMBODIMENTS

Components of optical glass of the invention are limited to the above for the following reasons. First, SiO₂ is a component making up a glass skeleton (glass former). An SiO₂ content of less than 10% results in deterioration in the glass durability. On the other hand, a SiO₂ content of 38% results in deterioration in the devitrification resistance and also difficulty in obtaining glass of a high refractive index. Thus, the range of SiO₂ content was defined 10 to 38%, and a more preferable range of SiO₂ content is 10 to 36%.

As is the case with SiO₂, B₂O₃ is a component making up a glass skeleton. A B₂O₃ content of less than 15% results in increased likelihood of glass devitrification. On the other hand, a B₂O₃ content of over 40% results in a decrease in the refractive index, thus failing to obtain a desired optical constant. Thus, the range of B₂O₃ content was defined 15 to 40%, and a more preferable range of B₂O₃ content is 15 to 39%.

Li₂O is very effective in lowering the Tg. A Li₂O content of less than 4% results in failure to satisfactorily provide the aforementioned effect. On the other hand, a Li₂O content of over 14% results in difficulty in obtaining glass of a high refractive index and also results in deterioration in the glass durability. Thus, the range of Li₂O content was defined 4 to 14%, and a more preferable range of Li₂O content is 4 to 13%.

Na₂O and K₂O are useful as components for lowering the Tg, but containing each in a content of over 5% results in remarkable deterioration in the devitrification resistance. Thus, the range of both Na₂O and K₂O contents was defined 0 to 5% (zero inclusive).

A R₂O (R═Li, Na, K) component in a total content of less than 4% results in insufficient effect provided in lowering the Tg. On the other hand, the R₂Ocomponent in a total content of over 20% results in difficulty in providing glass of a high refractive index and also results in deterioration in the glass durability. Thus, the range of total content of R₂O was defined 4 to 20%, and a more preferable range of total content of R₂O is 4 to 18%.

MgO is effective in glass weight saving and improving in the refractive index of glass, and further in lowering dispersion. Containing MgO in a content of over 10% results in unstable glass and deterioration in the devitrification resistance. Thus, the range of MgO content was defined 0 to 10% (zero inclusive).

CaO is effective in glass weight saving and improving the refractive index and the glass durability. Containing CaO in a content of over 10% results in unstable glass and deterioration in the devitrification resistance. Thus, the range of CaO content was defined 0 to 10% (zero inclusive).

BaO is effective in adjusting the refractive index and improving the glass stability. A BaO content of over 10% results in deterioration in the devitrification resistance. Thus, the range of BaO content was defined 0 to 10% (zero inclusive).

SrO is effective in lowering the TL and improving the glass stability. An SrO content of over 10% results in deterioration in the devitrification resistance. Thus, the range of SrO content was defined 0 to 10% (zero inclusive).

ZnO is effective in increasing the refractive index, maintaining dispersion, and lowering the T_{L}. In addition, ZnO is effective in lowering the Tg to ensure favorable viscosity, and thus is an important component in the optical glass of the invention. A ZnO content of less than 15% results in a decrease in the refractive index thus failing to provide a desired optical constant. On the other hand, a ZnO content of over 39% results in deterioration in the devitrification resistance. Thus, the range of ZnO content was defined 15 to 39%, and a more preferable range of ZnO content is 15 to 38%.

An R′O (R′=Mg, Ca, Ba, Sr, Zn) component in a total content of less than 15% results in a decrease in the refractive index thus failing to provide a desired optical constant. On the other hand, an R′O component in a total content of over 39% results in deterioration in the devitrification resistance. Thus, the range of the total content of R′O was defined 15 to 39%, and a more preferable range of the total content of R′O is 15 to 38%.

In the optical glass of the invention, one or two or more kinds of glass components including Y₂O₃, La₂O₃, Gd₂O₃, TiO₂, ZrO₂, Nb₂O₅, Ta₂O₅, WO₃, and Sb₂O_{3,} and Bi₂O₃ may be additionally contained in a specific amount when necessary. Components were limited to these components for the following reasons.

Al₂O₃ is effective in improving the viscosity, but an Al₂O₃ content of over 20% results in deterioration in the devitrification resistance of glass and also deterioration in the fusibility thereof. Thus, the range of Al₂O₃ content was defined 0 to 20%.

Y₂O₃ is effective in increasing the refractive index of glass. A Y₂O₃ content of over 5% results in deterioration in the devitrification resistance of glass and an increase in the T_{L}. Thus, the range of Y₂O₃ content was defined 0 to 5%.

La₂O₃ is effective in increasing the refractive index of glass and also maintaining dispersion. An La₂O₃ content of over 5% results in strong phase separation and an increase in the TL. Thus, the range of La₂O₃ content was defined 0 to 5%.

Gd₂O₃ is effective in increasing the refractive index of glass, improving the resistance thereof to climate, and lowering the T_{L}. A Gd₂O₃ content of over 5% results in deterioration in the devitrification resistance of glass. Thus, the range of Gd₂O₃ content was defined 0 to 5%.

TiO₂ is effective in increasing the refractive index. A TiO₂ content of over 5% results in deterioration in the devitrification resistance of glass and an increase in the T_{L}. Thus, the range of TiO₂ content was defined 0 to 5%.

ZrO₂ is effective in increasing the refractive index of glass and increasing the resistance thereof to climate. A ZrO₂ content of over 5% results in deterioration in the devitrification resistance of glass and an increase in the T_{L}. Thus, the range of ZrO₂ content was defined 0 to 5%.

Nb₂O₅ is effective in increasing the refractive index of glass and improving the fusibility thereof. An Nb₂O₅ content of over 5% results in failure to maintain predetermined dispersion. Thus, the range of Nb₂O₅ content was defined 0 to 5%.

Ta₂O₅ is effective in increasing the refractive index of glass and improving the resistance thereof to climate. A Ta₂O₅ content of over 5% results in deterioration in the devitrification resistance of glass thus increasing the T_{L}. Thus, the range of Ta₂O₅ content was defined 0 to 5%.

WO₃ is effective in increasing the refractive index of glass and lowering the T_{L}. A WO₃ content of over 10% results in deterioration in the degree of pigmentation of glass. Thus, the range of WO₃ content was defined 0 to 10%.

Bi₂O₃ is effective in increasing the refractive index of glass. A Bi₂O₃ content of over 5% results in deterioration in the degree of pigmentation of glass. Thus, the range of Bi₂O₃ content was defined 0 to 5%.

Sb₂O₃ is effective, when added in a small amount, in improving the clarification action. Thus, the range of Sb₂O₃ content was defined 0 to 2%.

Needless to say, to the optical glass of the invention, a conventionally known glass component and additive agent, such as CuO, GeO₂, and the like, may be added, when necessary, within a range that does not impair the effects of the invention.

The optical element of the invention is fabricated by press-molding optical glass. As press-molding methods thereof, there are: a direct press-molding method in which molten glass is dropped from a nozzle into a mold heated to a predetermined temperature and then press-molded; and a reheating molding method in which a preform material, placed in a mold, is heated to a glass softening point or higher and then press-molded. According to such methods, polishing and grinding processes are no longer required, which results in improved productivity and also permits providing an optical element of a shape, such as a free-formed shape or an aspherical shape, which is difficult to process.

For the molding condition, although different depending on the shape of a glass component and a molded object or the like, the mold temperature is typically preferably in the range from 350 to 600° C., and more preferably in a temperature range close to the glass transition temperature. The press time is preferably in the range from several seconds to several tens of seconds. The pressing pressure is preferably in the range form 2×10⁷N/m² to 6×10⁷N/m² depending on the shape and size of a lens, and thus higher pressure permits molding with higher accuracy.

The optical element of the invention can be use as, for example, a lens of a digital camera, a collimating lens of a laser beam printer, a prism, a mirror, or the like.

### EXAMPLES

Hereinafter, the invention will be described more in detail, referring to examples, although the invention is not limited thereto.

### Examples 1 to 10, Comparative Examples 1 to 3

Samples were produced in the following manner. General glass raw materials, such as an oxide raw material, carbonate, nitrate, and the like, were blended together to provide target composition shown in Table 1 and then were sufficiently mixed together in powdery state to thereby prepare a blended material. Then, they were introduced into a fusion furnace heated to 1,000 to 1,300° C., fused and clarified, then stirred and homogenized, cast into a mold of iron or carbon previously heated, and then annealed. Subsequently, the refractive index (n_{d}) and Abbe number (v_{d}) for a d line, the glass transition temperature (Tg), the linear thermal expansion coefficient (α), the liquid phase temperature (T_{L}), and the viscosity at the liquid phase temperature were measured for each sample. Table 1 also shows the results of this measurement.

Example 1 in patent document 1 (JP-A-H3-5341) was retested for Comparative example 1, Example 1 in patent document 2 (JP-A-H6-107425) was retested for Comparative example 2, and Example 11 in patent document 3 (JP-A-2003-176151) was retested for Comparative example 3.

The aforementioned measurement on the physical properties was performed based on Test methods specified by Optical Glass Industrial Standards (JOGIS), as shown in detail below.

a) Refractive Index (n_{d}) and Abbe Number (v_{d})

As described above, the glass fused and cast in the mold was annealed down to the room temperature at a rate of −30° C./hour, and then providing it as a sample, measurement was conducted by using “KPR-200” manufactured by Kalnew Co., Ltd.

b) Glass Transition Temperature (Tg) and Linear Thermal Expansion Coefficient (α)

Measurement was conducted with a temperature rise of 10° C./hour by using a thermomechanical analyzer “TMA/SS6000” manufactured by Seiko Instruments Inc.

c) Liquid Phase Temperature (T_{L})

Using a fusion furnace, the temperature of the glass melted at 1,200° C. was reduced to a predetermined temperature at a rate of −100° C./hour and then held at this predetermined temperature for 12 hours. Then, the glass was poured into the mold and cooled down to the room temperature. Temperature at which no devitrification (crystal) was confirmed inside the glass was defined as liquid phase temperature. The inside of the glass was observed by using, with 100× magnification, an optical microscope “BX50” manufactured by Olympus Corporation

d) Viscosity

Measurement was conducted by using a high temperature viscosity measuring instrument “TVB-20H type viscometer” manufactured by Advantest Corporation.

Table 1

As can be clearly seen in Table 1, the optical glass samples of Examples 1 to 10 had refractive indexes of 1.558 to 1.616 and Abbe numbers of 54.4 to 58.8, and thus had optical constants of low dispersion and intermediate refractive index, and further had a Tg of equal to or less than 492° C., and thus were suitable for press-molding. These optical glass samples had a T_{L} of 950° C. or less and a viscosity of 1.0 poise or more at T_{L}, and thus were excellent in devitrification resistance and moldability.

On the contrary, the optical glass of Comparative Example 1, having a SiO₂ content of as large as 40.0% and containing no ZnO, had an Abbe number of as large as 61.0, and a Tg and a T_{L} of as high as 545° C. and 1050° C., respectively. The optical glass of Comparative Example 2, having an SiO₂ content of as large as 55.0% and a B₂O₃ content of as small as 10.0% and also containing no ZnO, had a Tg of as high as 525° C., and thus was not suitable for press-molding. The optical glass of Comparative Example 2 also had a liquid phase temperature T_{L} of as high as 1030° C., and thus was inferior in devitrification resistance. The optical glass of Comparative Example 3, having an SiO₂ content of as large as 41.0% and a ZnO content of as small as 4.0%, also had a Tg of as high as 596° C. or more, and thus was not suitable for press-molding, and also had a liquid phase temperature T_{L} of as high as 1080° C., and thus was inferior in devitrification resistance.

TABLE 1

| | | Example | | | | | | |
|---|---|---|---|---|---|---|---|---|
| | | 1 | 2 | 3 | 4 | 5 | 6 | 7 |
| Composition | SiO₂ | 17.0 | 29.0 | 36.0 | 26.0 | 27.0 | 25.0 | 20.0 |
| (weight %) | Al₂O₃ | 13.0 | 13.0 | 17.0 | 15.0 | 11.0 | 6.0 | 5.0 |
| | B₂O₃ | 39.0 | 18.5 | 15.0 | 24.0 | 27.0 | 29.0 | 27.0 |
| | Li₂O | 8.0 | 13.0 | 9.0 | 9.0 | 8.0 | 8.0 | 7.0 |
| | Na₂O | 4.0 | 4.0 | 2.0 | 2.0 | | | |
| | K₂O | 4.0 | | 3.0 | 3.0 | | | |
| | MgO | | | | | | | 8.0 |
| | CaO | | | | | | | 7.0 |
| | BaO | | | | | | | |
| | SrO | | | | | | | |
| | ZnO | 15.0 | 18.0 | 15.0 | 17.0 | 27.0 | 25.0 | 18.0 |
| | Y₂O₃ | | | | | | | |
| | La₂O₃ | | | | | | | |
| | Gd₂O₃ | | | | | | | |
| | TiO₂ | | 3.0 | | | | | |
| | ZrO₂ | | | 3.0 | | | | |
| | Nb₂O₅ | | | | | | 4.0 | |
| | Ta₂O₅ | | | | 4.0 | | 3.0 | |
| | Sb₂O₃ | | 1.5 | | | | | |
| | Bi₂O₃ | | | | | | | |
| | WO₃ | | | | | | | 8.0 |

| | | | | | | | |
|---|---|---|---|---|---|---|---|
| R₂O(Li₂O + Na₂O + K₂O) | 16.0 | 17.0 | 14.0 | 14.0 | 8.0 | 8.0 | 7.0 |
| R′O(MgO + CaO + BaO + SrO + ZnO) | 15.0 | 18.0 | 15.0 | 17.0 | 27.0 | 25.0 | 33.0 |
| Refractive index (nd) | 1.558 | 1.566 | 1.568 | 1.575 | 1.585 | 1.596 | 1.601 |
| Abbe number (νd) | 58.8 | 57.2 | 55.9 | 55.8 | 56.4 | 55.7 | 54.4 |
| Glass transition point (° C.) | 438 | 426 | 445 | 443 | 470 | 471 | 468 |
| Liquid phase temperature T_{L} (° C.) | 900 | 890 | 880 | 860 | 880 | 900 | 920 |
| Viscosity at T_{L} (poise) | 14.0 | 61.5 | 72.0 | 55.5 | 41.0 | 22.0 | 15.0 |

| | | Example | | | Comparative Example | | |
|---|---|---|---|---|---|---|---|
| | | 8 | 9 | 10 | 1 | 2 | 3 |
| Composition | SiO₂ | 20.0 | 12.0 | 26.0 | 40.0 | 55.0 | 41.0 |
| (weight %) | Al₂O₃ | 6.0 | 8.0 | | 5.0 | 3.0 | 3.0 |
| | B₂O₃ | 32.0 | 33.0 | 24.0 | 19.0 | 10.0 | 19.0 |
| | Li₂O | 4.0 | 6.0 | 9.0 | 5.0 | 8.0 | 3.7 |
| | Na₂O | | | | | | 2.0 |
| | K₂O | | | 3.0 | | | 1.0 |
| | MgO | | | | 2.0 | | |
| | CaO | | | | 1.0 | | 2.0 |
| | BaO | 7.0 | | | 23.5 | 7.0 | 5.0 |
| | SrO | 8.0 | | | | 14.0 | |
| | ZnO | 20.0 | 38.0 | 27.0 | | | 4.0 |
| | Y₂O₃ | 3.0 | | | | | |
| | La₂O₃ | | | 5.0 | 4.5 | | 16.2 |
| | Gd₂O₃ | | | 5.0 | | | 1.0 |
| | TiO₂ | | | | | 1.0 | |
| | ZrO₂ | | | | | | |
| | Nb₂O₅ | | | | | 2.0 | |
| | Ta₂O₅ | | | | | | 1.0 |
| | Sb₂O₃ | | | 1.0 | | | 0.1 |
| | Bi₂O₃ | | 3.0 | | | | 1.0 |
| | WO₃ | | | | | | |

| | | | | | | |
|---|---|---|---|---|---|---|
| R₂O(Li₂O + Na₂O + K₂O) | 4.0 | 6.0 | 12.0 | 5.0 | 8.0 | 6.7 |
| R′O(MgO + CaO + BaO + SrO + ZnO) | 35.0 | 38.0 | 27.0 | 26.5 | 21.0 | 11.0 |
| Refractive index (nd) | 1.602 | 1.611 | 1.616 | 1.589 | 1.578 | 1.615 |
| Abbe number (νd) | 55.0 | 54.5 | 54.6 | 61.0 | 57.8 | 55.6 |
| Glass transition point (° C.) | 492 | 473 | 462 | 545 | 525 | 596 |
| Liquid phase temperature T_{L} (° C.) | 950 | 880 | 900 | 1050 | 1030 | 1080 |
| Viscosity at T_{L} (poise) | 9.5 | 5.5 | 1.0 | 92.0 | 85.5 | 145.0 |

What is claimed is:

1. Optical glass for press-molding, comprising the following glass components in % by weight:
10 to 38% of SiO₂,
15 to 40% of B₂O₃,
4 to 14% of Li₂O,
0 to 5% (zero inclusive) of Na₂O,
0 to 5% (zero inclusive) of K₂O,
where a total content of Li₂O+Na₂O+K₂O is equal to 4 to 20%,
0 to 10% (zero inclusive) of MgO,
0 to 10% (zero inclusive) of CaO,
0 to 10% (zero inclusive) of BaO,
0 to 10% (zero inclusive) of SrO, and
15 to 39% of ZnO,
where a total content of MgO+CaO+BaO+SrO+ZnO is equal to 15 to 39%.

2. The optical glass for press-molding according to claim 1, further containing one or two or more kinds of the following glass components in % by weight:
0 to 20% of Al₂O₃,
0 to 5% of Y₂O₃,
0 to 5% of La₂O₃,
0 to 5% of Gd₂O₃,
0 to 5% of TiO₂,
0 to 5% of ZrO₂,
0 to 5% of Nb₂O₅,
0 to 5% of Ta₂O₅,
0 to 10% of WO₃,
0 to 2% of Sb₂O₃, and
0 to 5% of Bi₂O₃.

3. The optical glass for press-molding according to claim 1, wherein a refractive index (n_{d}) is in a range from 1.55 to 1.62, an Abbe number (v_{d}) is in a range from 54 to 60, and a glass transition temperature (Tg) is 500° C. or less.

4. The optical glass for press-molding according to claim 1,
wherein a liquid phase temperature (T_{L}) is 1,000° C. or less, and viscosity at the liquid phase temperature is 0.5 poise or more.

5. An optical element comprising the optical glass for press-molding according to claim 1.

6. The optical glass for press-molding according to claim 1,
wherein an SiO₂ content is 10 to 36%.

7. The optical glass for press-molding according to claim 1,
wherein a B₂O₃ content is 15 to 39%.

8. The optical glass for press-molding according to claim 1,
wherein an Li₂O content is 4 to 13%.

9. The optical glass for press-molding according to claim 1,
wherein a total content of Li₂O+Na₂O+K₂O is 4 to 18%.

10. The optical glass for press-molding according to claim 1,
wherein a ZnO content is 15 to 38%.

11. The optical glass for press-molding according to claim 1,
wherein a total content of MgO+CaO+BaO+SrO+ZnO is 15 to 38%.

12. Optical glass comprising the following glass components in % by weight:
10 to 38% of SiO₂,
0 to 20% (zero inclusive) of Al₂O₃,
15 to 40% of B₂O₃,
4 to 14% of Li₂O,
0 to 5% (zero inclusive) of Na₂O,
0 to 5% (zero inclusive) of K₂O,
where a total content of Li₂O+Na₂O+K₂O is equal to 4 to 20%,
0 to 10% (zero inclusive) of MgO,
0 to 10% (zero inclusive) of CaO,
0 to 10% (zero inclusive) of BaO,
0 to 10% (zero inclusive) of SrO, and
15 to 39% of ZnO,
where a total content of MgO+CaO+BaO+SrO+ZnO is equal to 15 to 39%.

13. The optical glass according to claim 12, further containing one or two or more kinds of the following glass components in % by weight:
0 to 5% of Y₂O₃,
0 to 5% of La₂O₃,
0 to 5% of Gd₂O₃,
0 to 5% of TiO₂,
0 to 5% of ZrO₂,
0 to 5% of Nb₂O₅,
0 to 5% of Ta₂O₅,
0 to 10% of WO₃,
0 to 2% of Sb₂O₃, and
0 to 5% of Bi₂O₃.

14. The optical glass according to claim 12,
wherein an SiO₂ content is 10 to 36%.

15. The optical glass according to claim 12,
wherein a B₂O₃ content is 15 to 39%.

16. The optical glass according to claim 12,
wherein an Li₂O content is 4 to 13%.

17. The optical glass according to claim 12,
wherein a total content of Li₂O+Na₂O+K₂O is 4 to 18.

18. The optical glass according to claim 12,
wherein a ZnO content is 15 to 38%.

19. The optical glass according to claim 12,
wherein a total content of MgO+CaO+BaO+SrO+ZnO is 15 to 38%.
